(19) United States
(12) Patent Application Publication
(10) Pub. No.: US 2012/0301012 A1
(43) Pub. Date: Nov. 29, 2012

(54) IMAGE SIGNAL PROCESSING DEVICE AND IMAGE SIGNAL PROCESSING METHOD

(75) Inventors: Yasuki KAKISHITA, Kokubunji (JP); Isao KARUBE, Fujisawa (JP); Kenichi YONEJI, Kodaira (JP); Koichi HAMADA, Kawasaki (JP); Yoshitaka HIRAMATSU, Sagamihara (JP)

(73) Assignee: HITACHI CONSUMER ELECTRONICS CO., LTD., Tokyo (JP)

(21) Appl. No.: 13/477,525

(22) Filed: May 22, 2012

(30) Foreign Application Priority Data
May 27, 2011 (JP) 2011-118634

(51) Int. Cl. G06K 9/00

(52) U.S. Cl. 382/154

(57) ABSTRACT

When super-resolution processing is applied to an entire screen image at the same intensity, a blur contained in an input image is uniformly reduced over the entire screen image. Therefore, the screen image may be seen differently from when it is naturally seen. As one of methods for addressing the problem, there is such a method that: when a first image for a left eye and a second image for a right eye are inputted, each of parameters concerning image-quality correction is determined based on a magnitude of a positional deviation between associated pixels in the first image and second image respectively; and the parameters are used to perform image-quality correction processing for adjusting a sense of depth of an image.

### CLAIMS OF PRIORITY

The present application claims priority from Japanese patent application serial No. JP2011-118634 filed on May 27, 2011, the content of which is hereby incorporated by reference into this application.

### BACKGROUND OF THE INVENTION

The present invention relates to an image processing technology for three-dimensional pictures.

In recent years, contents of three-dimensional pictures that permit stereoscopic vision have attracted attention.

To the three-dimensional picture, many image processing technologies that have been developed for two-dimensional pictures are applied. For example, super-resolution processing for transforming an image into a high-resolution image is cited.

As for existing three-dimensional picture delivery methods, a mainstream method is called a side-by-side method in which one screen image is bisected into left and right areas and pictures for respective eyes are allocated to the areas. This method is confronted with a problem that the resolution in a horizontal direction is a half of that of a two-dimensional picture. Therefore, a method of attaining a high resolution using super-resolution processing is adopted.

### SUMMARY OF THE INVENTION

However, for example, assuming that super-resolution processing is applied to an entire screen image at the same intensity, a blur contained in an original image is uniformly diminished over the entire screen image. Therefore, the image may be seen differently from when it is seen naturally.

The same applies to, for example, contrast correction processing or high-frequency component enhancement processing. When the processing is uniformly performed on the entire screen image, the image may be seen differently from when it is seen naturally.

Methods described in Japanese Patent Application Laid-Open publication No. 2009-251839 and Japanese Patent Application Laid-Open Publication No. 11-239364 address the foregoing problem, wherein a depth is estimated based on a frequency component representing a segmented area, and image processing is performed according to the estimated depth.

However, depth estimation is supposed to be applied to a two-dimensional picture, and a picture to be employed is supposed to be the two-dimensional picture. Therefore, the depth cannot always be estimated accurately.

Accordingly, an object of the present invention is to provide a high-quality three-dimensional picture, which gives a sense of stereoscopy, by estimating a depth on the basis of a parallax of a three-dimensional picture, and implementing high-resolution attainment processing on a noted area alone according to the depth.

One of means for addressing the aforesaid problem is an image signal processing method in which when a first image for a left eye and a second image for a right eye are inputted, each of parameters concerning image-quality correction is determined based on a magnitude of a positional deviation between associated pixels in the first image and second image respectively, and the parameters are used to perform image-quality correction processing for adjusting a sense of depth of an image.

According to the present invention, a more natural high-quality three-dimensional picture can be provided.

### BRIEF DESCRIPTION OF THE DRAWINGS

FIG. 1 is a block diagram of an image signal processing device in accordance with a first embodiment;

FIG. 2 is a diagram showing an example of image inputs represented by a three-dimensional picture signal;

FIG. 3 is a diagram showing actions of a depth estimation unit (103);

FIG. 4 is a block diagram of a parameter determination unit;

FIG. 5 is a block diagram of an image-quality correction processing unit;

FIG. 6 is a block diagram of an image signal processing device in accordance with a second embodiment;

FIG. 7 is a diagram showing actions of a depth estimation unit (603);

FIG. 8 is a block diagram of an image-quality correction processing unit;

FIG. 9 includes graphs showing a relationship of association of a parameter intensity to a depth signal;

FIG. 10 includes graphs showing a relationship of association of a parameter intensity to a depth signal;

FIG. 11 shows an example of a sigmoid function;

FIG. 12 is a diagram of a system configuration of an image signal processing system;

FIG. 13 is a diagram of a system configuration of an image signal processing system; and

FIG. 14 is a block diagram showing the image coding device.

### DESCRIPTION OF THE PREFERRED EMBODIMENTS

Embodiments will be described below. Noted is that the present invention is not limited to the embodiments.

### First Embodiment

A first embodiment attains a high resolution for a noted area by utilizing depth information based on a parallax obtained from a left-eye image signal and a right-eye image signal which constitute a three-dimensional picture signal, and thus realizes a more natural high-quality three-dimensional picture.

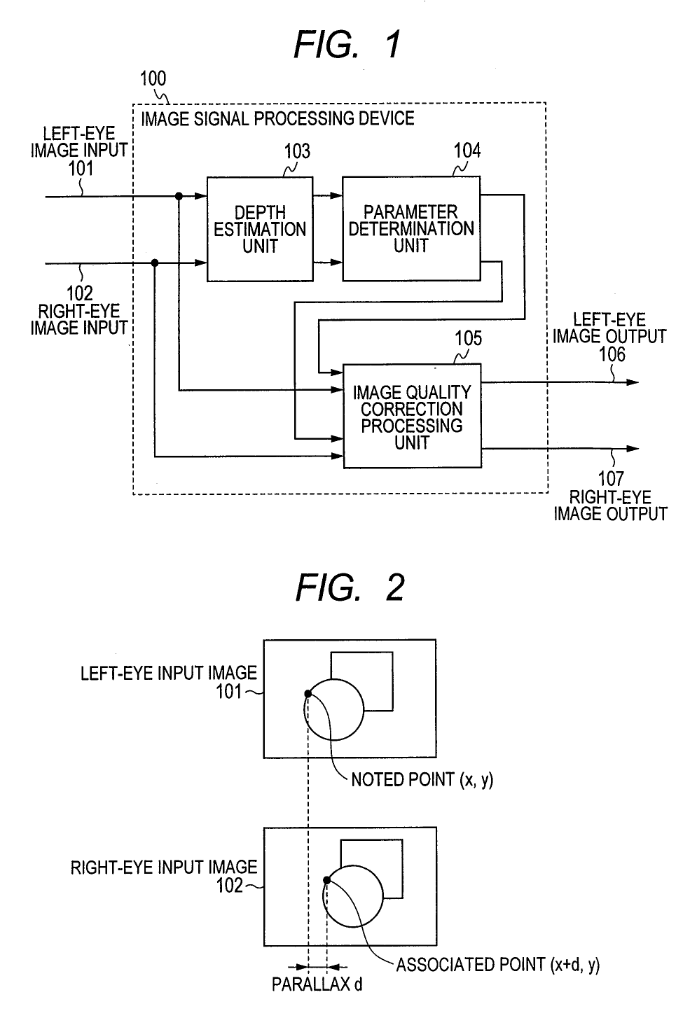

FIG. 1 is a block diagram of an image signal processing device in accordance with the first embodiment. In the image signal processing device 100 in FIG. 1, a left-eye image signal 101 and a right-eye image signal 102 are inputted. The inputted image signals are fed to each of a depth estimation unit 103 and an image-quality correction processing unit 105.

FIG. 2 shows an example of input images represented by a three-dimensional picture signal. The left-eye image 101 and right-eye image 102 are different from each other in the horizontal position of an object that depends on a depth. This deviation in horizontal direction is expressed as a parallax.

The depth estimation unit 103 estimates a depth on the basis of a parallax between the left-eye image and right-eye image.

A parameter determination unit 104 determines parameters, which are employed in image-quality correction processing, on the basis of depth signals outputted from the depth estimation unit 103.

The parameter determination unit 104 may calculate a left-eye parameter and a right-eye parameter using left and right depth signals. If the left-eye parameter and right-eye parameter are obtained independently of each other, the parameter determination unit may be divided into a left-eye parameter determination unit and a right-eye parameter determination unit.

The image-quality correction processing unit 105 uses the parameters outputted from the parameter determination unit 104 to perform image-quality correction processing on inputted images, and outputs a left-eye image signal 106 and a right-eye image signal 107. The image-quality correction processing unit 105 may comprehensively perform left-eye image-quality correction processing and right-eye image-quality correction processing, or may perform the pieces of processing independently of each other.

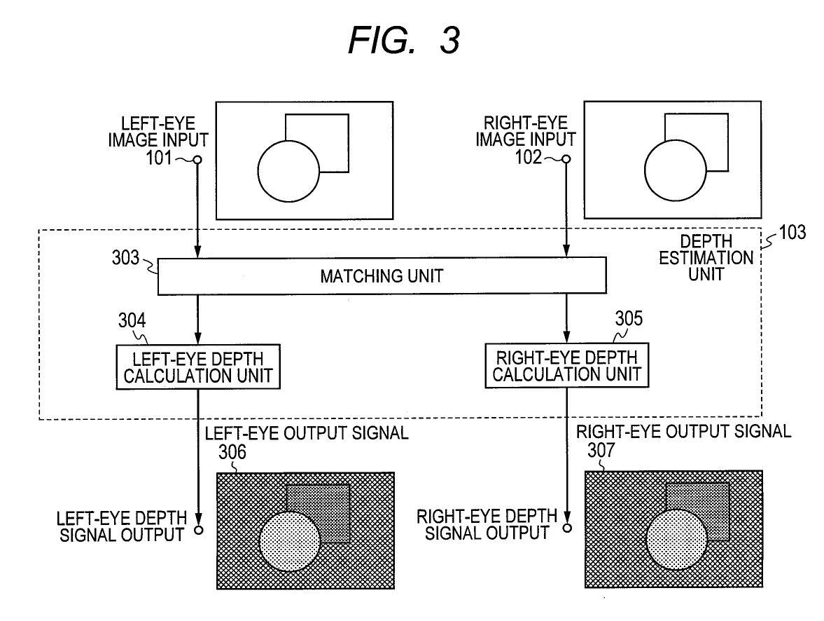

Referring to FIG. 3, actions of the depth estimation unit 103 will be described below.

A left-eye image 101 and right-eye image 102 are inputted to the depth estimation unit 103. The left-eye image and right-eye image have a parallax, and are different from each other in a depth according to the magnitude of the parallax or whether the parallax is positive or negative. With which area in the right-eye image a certain area in the left-eye image is associated is searched in order to obtain the parallax in a horizontal direction. Thus, the depth can be obtained.

A matching unit 303 searches associated areas in a left-eye image and right-eye image. As a method of matching, for example, block matching in which a sum of absolute differences (SAD) is regarded as a degree of similarity is cited.

A left-eye depth calculation unit 304 and right-eye depth calculation unit 305 each calculates a depth signal using an output of the matching unit 303. When block matching in which a SAD is regarded as a degree of similarity is employed, when two areas are more similar to each other, the SAD value gets smaller. A parallax causing the SAD value to become minimal is selected and used as depth information. In the present embodiment, the parallax is used as depth information in matching. Any information other than the parallax may be used to correct the parallax, and the resultant parallax may be regarded as the depth information. The calculated depth information becomes an output of each of the left-eye depth calculation unit 304 and right-eye depth calculation unit 305.

A left-eye output signal 306 and right-eye output signal 307 are an example of an output of the depth estimation unit 103. In this example, when an object is located at a deeper position, the object is displayed to be more blackish. When the object is located at a nearer position, the object is displayed to be more whitish. The present invention is not limited to this mode. An output should merely represent an intensity that varies depending on a depth.

The depth signals outputted from the depth estimation unit 103 are inputted to the parameter determination unit 104.

The parameter determination unit 104 produces image-quality correction processing parameters on the basis of the inputted depth signals. The image-quality correction processing unit 105 performs image-quality correction processing according to the parameters outputted from the parameter determination unit 104.

As for an example of an image-quality correction processing parameter, when the image-quality correction processing unit 105 employs high-resolution attainment processing described in “Fast and Robust Multi-frame Super-Resolution”by Sina Farsiu et al., IEEE Transactions on Image processing, Vol. 13, No. 10, October 2004 or “Super-Resolution Image Reconstruction: A Technical Overview” by Sung Cheol Park et al., IEEE Signal Processing Magazine, May 2003, p. 21-36, a blur reduction transfer function is used as the parameter.

In this case, a transfer function for use in reducing an image blur that occurs during imaging is needed as a parameter. In general, the transfer function is manifested by a low-pass filter coefficient. When the low-pass filer coefficient is set to a value associated with intense low-pass filter processing, a blur reduction effect of high-resolution attainment processing is intensified. In contrast, when the low-pass filter coefficient is set to a value associated with feeble low-pass filter processing, the blur reduction effect of the high-resolution attainment processing is weakened. By utilizing the nature, the filter coefficient bringing about the high blur reduction effect is applied as a parameter to a noted area, and the filter coefficient bringing about the low blur reduction effect is applied as the parameter to the other area. Thus, more natural high-resolution processing can be performed on a three-dimensional picture.

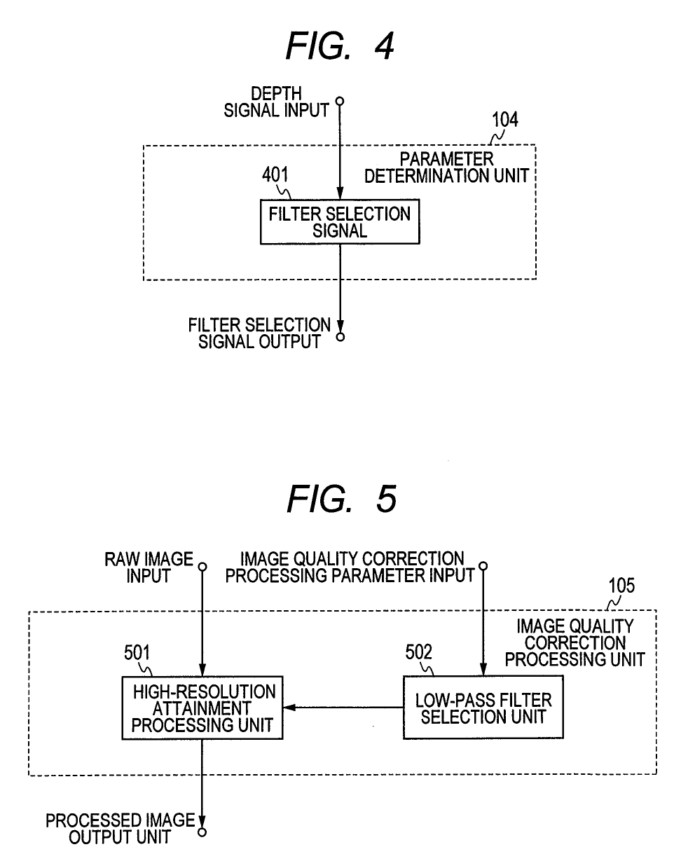

FIG. 4 shows an example of the configuration of the parameter determination unit. A filter is selected for an inputted depth signal in order to calculate an image-quality correction processing parameter.

For example, when an image is formed so that a distant view therein causes a negative parallax and a near view therein causes a positive parallax, an area that normally brings about a zero parallax contains a point of a focal length. Therefore, the area that brings about the zero parallax is regarded as a noted area, and a filter coefficient that provides a high blur reduction effect is selected as a parameter. When the absolute value of the parallax gets larger, a filter coefficient that provides a lower blur reduction effect is selected as the parameter. Thus, a more natural high-resolution three-dimensional picture can be realized. When a point of the zero parallax is set to infinity, the noted area may be estimated through blur estimation processing, which is employed in a second embodiment, or based on a value obtained by normalizing the parallax, and the filter coefficient may be modified.

FIG. 5 shows an example of the image-quality correction processing unit. According to the image-quality correction parameter outputted from the parameter determination unit, a low-pass filter selection unit 502 varies a low-pass filter coefficient for each pixel or partial area in an image. For example, some filters having different coefficients are made available, and any of the filters is selected based on the image-quality correction parameter. A high-resolution attainment processing unit 501 performs high-resolution attainment.

Accordingly, the intensity of a low-pass filter to be employed in high-resolution attainment processing of the image-quality correction processing unit 105 can be varied for each pixel or partial area in an image. While a sense of perspective is held intact, an image blur occurring during imaging can be reduced and an image can be transformed into a high-resolution image.

According to the first embodiment, a high resolution dependent on a depth can be attained, and a more natural sense of stereoscopy can be realized by controlling high-resolution processing.

### Second Embodiment

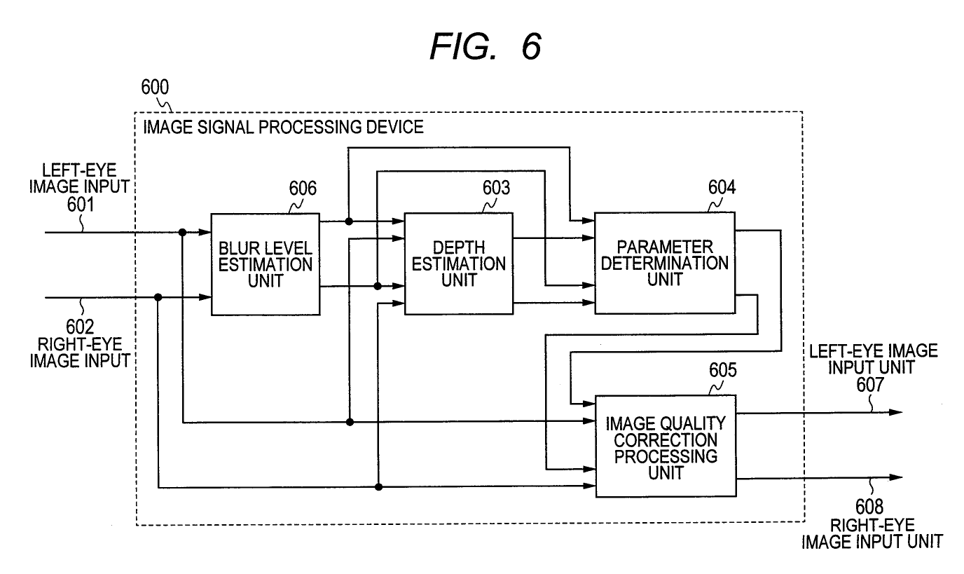

Referring to FIG. 6, an image signal processing device and image signal processing method in accordance with a second embodiment will be described below. In the second embodiment, a focal length is estimated based on a blur level, and high-resolution attainment processing is more intensely performed on an area that causes a parallax associated with the estimated focal length. The high-resolution attainment processing is feebly performed on the other area. Thus, a more natural three-dimensional picture is realized. The processing will be described below.

In an image signal processing device 600 according to the second embodiment, a left-eye image signal and right-eye image signal are inputted. The inputted image signals are fed to each of a blur level estimation unit 606, depth estimation unit 603, and image-quality correction processing unit 605.

The blur level estimation unit 606 estimates or calculates a blur level, that is, a degree of a blur in an image for each area in the image.

The depth estimation unit 603 estimates a depth on the basis of a parallax between the inputted left-eye image and right-eye image and the blur level outputted from the blur level estimation unit.

A parameter determination unit 604 determines each of parameters, which are employed in image-quality correction processing, on the basis of a depth signal outputted from the depth estimation unit 603 and the blur level outputted from the blur level estimation unit 606.

The image-quality correction processing unit 605 uses the parameters, which are outputted from the parameter determination unit 604, to perform image-quality correction processing on the inputted images, and then outputs the resultant images.

The blur level estimation unit 606 estimates blur levels of a left-eye image and right-eye image alike. As a concrete example of blur level estimation processing, a method of estimating a blur level by calculating a quantity of textures employed in an image is cited. For calculation of the quantity of textures in an image, for example, a method of calculating a degree of dispersion in an image from neighboring pixels can be employed. An area where the thus calculated quantity of textures is large can be recognized as a sharp image area, that is, an area of a low blur level. In contrast, an area where the quantity of textures is small can be recognized as a blurred image area, that is, an area of a high blur level. The blur level estimation processing may be performed on each partial area in a screen image or may be performed pixel by pixel.

The present invention is not limited to the foregoing method. Alternatively, any other method may be adopted for estimation. For example, edge information may be calculated, and whether an image is sharp or blurred may be determined based on the calculated edge information.

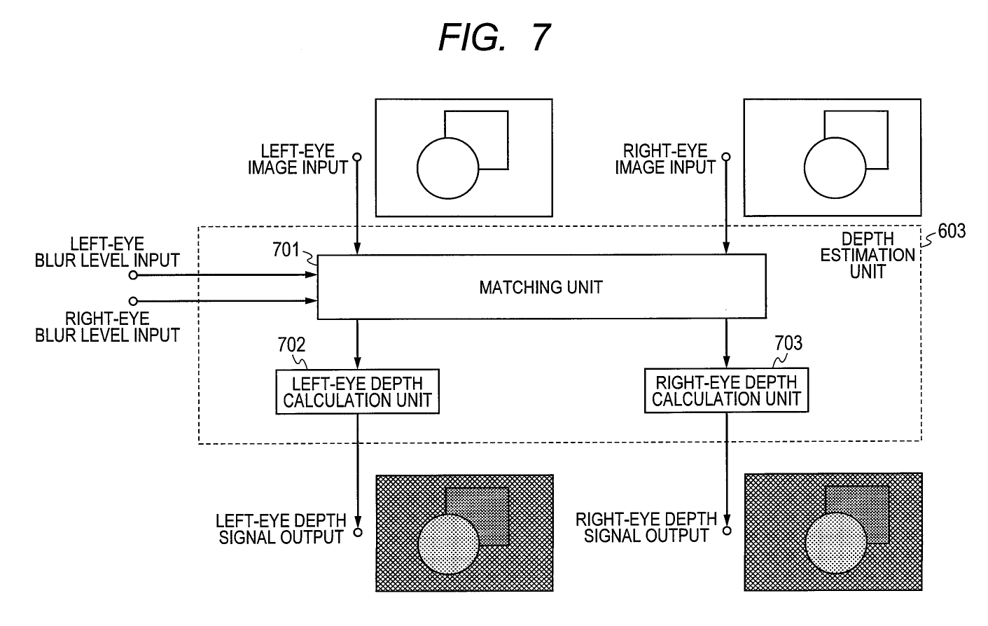

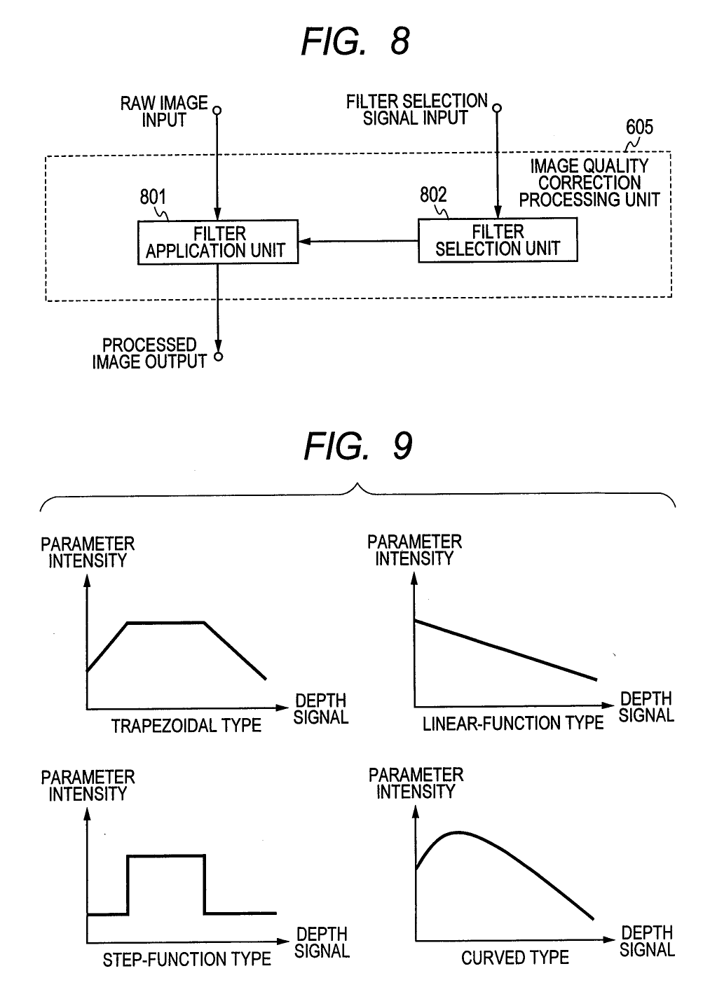

Referring to FIG. 7, actions of the depth estimation unit 603 will be described below.

Together with a left-eye image and right-eye image, a left-eye blur level and right-eye blur level that are an output of the blur level estimation unit 606 are inputted to the depth estimation unit 603.

Processing of estimating a depth on the basis of a parallax is identical to that in the first embodiment. A blur level may also be used to estimate the depth.

Depth signals outputted from the depth estimation unit 603 and the blur levels outputted from the blur level estimation unit 606 are fed to the parameter determination unit 604.

The parameter determination unit 604 produces image-quality correction processing parameters on the basis of the inputted depth signals and blur levels. The image-quality correction processing unit 605 performs image-quality correction processing according to the parameters outputted from the parameter determination unit 604.

In the image-quality correction processing unit 605, when high-resolution attainment processing described in “Fast and Robust Multi-frame Super-Resolution” by Sina Farsiu et al, IEEE Transactions on Image processing, Vol. 13, No. 10, October 2004 or “Super-Resolution Image Reconstruction: A Technical Overview” by Sung Cheol Park et al., IEEE Signal Processing Magazine, May 2003, p. 21-36 is employed, a blur reduction transfer function is used as an example of an image-quality correction processing parameter to be employed.

In this case, a transfer function for use in reducing an image blur that occurs during imaging is needed as a parameter. In general, the transfer function is manifested by a low-pass filter coefficient. When the low-pass filter coefficient is set to a value associated with intense low-pass filter processing, a blur reduction effect of high-resolution attainment processing is intensified. In contrast, when the low-pass filter coefficient is set to a value associated with feeble low-pass filter processing, the blur reduction effect of high-resolution attainment processing is weakened.

According to a depth calculated by the depth estimation unit 603, the low-pass filter coefficient is varied for each pixel or partial area in an image. For example, some filters having different coefficients are made available, and any of the filters is selected according to the depth. At this time, a blur level outputted from the blur level estimation unit 606 may be used to obtain a focal point for the purpose of determining which of the filters should be selected for each depth. For example, blur levels for respective depths are summated, and then normalized. A point of a depth associated with the lowest blur level is estimated as a focal point. Intense low-pass filter processing is set in relation to the point of the depth estimated as the focal point. Thus, the resolution of a noted object can be controlled to be high, and the resolution of the other area can be controlled to be lower.

Accordingly, the intensity of a low-pass filter in high-resolution attainment processing of the image-quality correction processing unit 605 can be varied for each pixel or partial area in an image. While a sense of perspective of the image is held intact, an image blur occurring during imaging can be reduced and an image can be transformed into a high-resolution image.

According to the second embodiment, a high resolution can be attained for a noted area, which is located at a point of a focal length, according to a depth. The image quality of a three-dimensional picture can be more naturally improved.

### Third Embodiment

An image signal processing device and image signal processing method in accordance with a third embodiment will be described below.

The image signal processing device in accordance with the third embodiment is different from the image signal processing device of the first embodiment shown in FIG. 1 or the image signal processing device of the second embodiment shown in FIG. 6 only in a filter characteristic to be outputted from the parameter determination unit and in processing to be performed by the image-quality correction processing unit. As for the other features, the image signal processing device in accordance with the third embodiment shares the same feature with the image signal processing devices in accordance with the first and second embodiments.

Herein, the parameter determination unit and image-quality correction processing unit will be described in conjunction with the example shown in FIG. 1.

The parameter determination unit 104 produces image-quality correction processing parameters on the basis of inputted depth signals. As described in relation to the second embodiment, a blur level may be used in addition to each of the depth signals. The image-quality correction processing unit 105 performs image-quality correction processing according to the parameters outputted from the parameter determination unit 104.

As an example of the image-quality correction processing parameter, when the image-quality correction processing unit 105 employs high-frequency band enhancement processing, a filter coefficient with which a high-frequency band is enhanced or attenuated is cited.

According to a depth calculated by the depth estimation unit 103, the filter coefficient is varied for each pixel or partial area in an image. For example, several filters having different coefficients are made available, and any of the filters is selected based on the depth. At this time, as described in relation to the second embodiment, a focal point may be calculated based on a blur level, and a depth for which a high-frequency component is most greatly enhanced may be determined.

Accordingly, the intensity of a filter employed in high-frequency band enhancement processing of the image-quality correction processing unit 105 can be varied for each pixel or partial area in an image. For example, the intensity of a high-frequency band enhancement processing filter is set to a high intensity for a noted area. For the other area, a high-frequency band is attenuated. Thus, while a sense of prospective of the image is held intact, a sense of stereoscopy can be enhanced. In this example, although the intensity of the high-frequency band enhancement processing filter can be set to the high intensity for the noted area, an area for which the intensity of the high-frequency band enhancement processing filter is raised is not limited to the noted area.

According to the third embodiment, high-frequency band enhancement can be performed according to a depth. Owing to high-frequency band enhancement control, the image quality of a three-dimensional image can more naturally be improved.

### Fourth Embodiment

An image signal processing device and image signal processing method in accordance with a fourth embodiment will be described below.

The image signal processing device in accordance with the fourth embodiment is different from the image signal processing device of the first embodiment shown in FIG. 1 or the image signal processing device of the second embodiment shown in FIG. 6 in an output of the parameter determination unit and in processing of the image-quality correction processing unit. As for the other features, the image signal processing device in accordance with the fourth embodiment shares the same features with those in accordance with the first and second embodiments.

The parameter determination unit 104 produces image-quality correction processing parameters on the basis of inputted depth signals. As described in relation to the second embodiment, not only the depth signal but also a blur level may be used. The image-quality correction processing unit 105 performs image-quality correction processing according to the parameters outputted from the parameter determination unit 104.

As an example of the image-quality correction processing parameter, when the image-quality correction processing unit 105 performs noise removal processing, if a bilateral filter expressed with an equation (1) is used to perform noise removal, a spatial dispersion coefficient σ1 or luminance value dispersion coefficient σ2 in the equation (1) is cited.

$$g ( i , j ) = \frac{\begin{matrix}{\sum }_{n = - w}^{w} {\sum }_{m = - w}^{w} f ( i + m , j + n ) exp ( - \frac{{m}^{2} + {n}^{2}}{2 {σ}_{1}^{2}} ) \\ exp ( - \frac{{( f ( i , j ) - f ( i + m , j + n ) )}^{2}}{2 {σ}_{2}^{2}} )\end{matrix}}{{\sum }_{n = - w}^{w} {\sum }_{m = - w}^{w} exp ( - \frac{{m}^{2} + {n}^{2}}{2 {σ}_{1}^{2}} ) exp ( - \frac{{( f ( i , j ) - f ( i + m , j + n ) )}^{2}}{2 {σ}_{2}^{2}} )} \qquad ( 1 )$$

where g(i,j) denotes an output luminance, f(i,j) denotes an input luminance, w denotes a filter size, σ1 denotes the spatial dispersion coefficient, and σ2 denotes the luminance value dispersion coefficient.

The spatial dispersion coefficient σ1 expresses a degree of dispersion over a distance from the position of a noted pixel to the position of a neighboring pixel. The luminance value dispersion coefficient σ2 expresses a degree of dispersion of a difference between the luminance of the noted pixel and the luminance of the neighboring pixel. In either of the coefficients, the larger the value is, the higher a noise removal effect is. However, a sense of image blurring also increases.

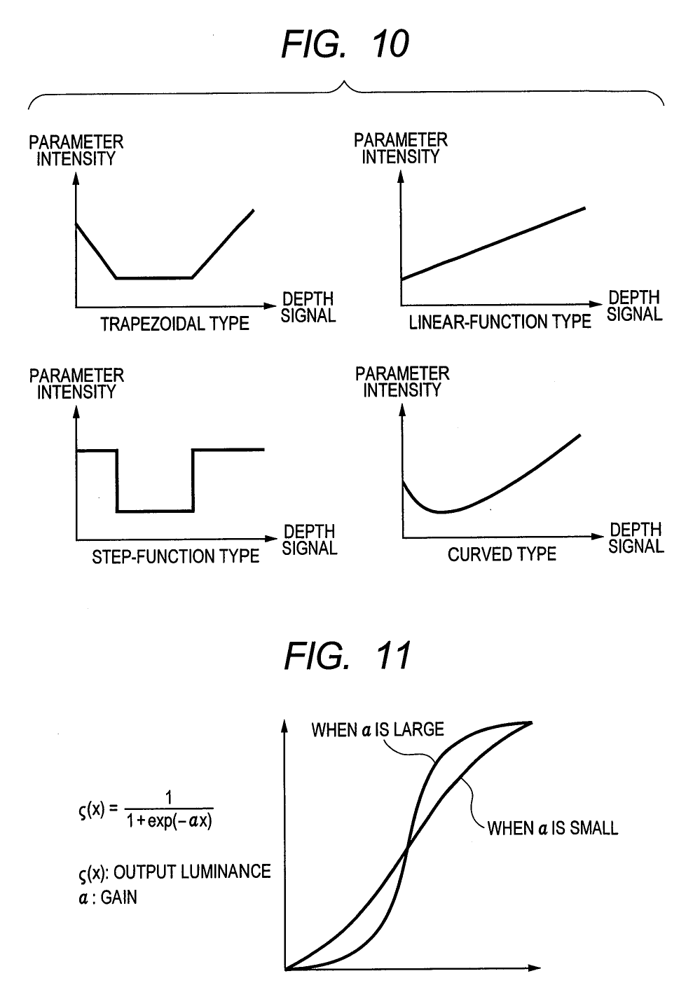

According to a depth calculated by the depth estimation unit 103, either or both of the coefficients σ1 and σ2 are varied for each pixel or partial area in an image. FIG. 10 includes graphs showing a relationship of association of a parameter intensity to a depth signal. The coefficient σ1 or σ2 is determined based on the association shown in FIG. 10. The association falls into a trapezoidal type in which the parameter intensity takes on a small value in a certain range of depth values, and takes on larger values in the other range of depth values, a step function type, a linear function type, or a curved type. Otherwise, a table to be referenced in order to determine the coefficient σ1 or σ2 for a depth may be made available so that the coefficient σ1 or σ2 can be set to an arbitrary value. As described in relation to the second embodiment, a focal area may be calculated based on a blur level, and a depth that causes the coefficient σ1 or σ2 to become minimal may be determined for any area in an image which indicates the same parallax as the parallax of the focal area.

Accordingly, the parameter to be employed in noise removal processing of the image-quality correction processing unit 105 can be varied for each pixel or partial area in an image. While a sense of perspective of the image is held intact, noise removal processing can be carried out. For example, a noise removal processing effect is weakened for a noted area, and is intensified for the other area. Thus, a high-quality three-dimensional picture can be realized while a more natural sense of stereoscopy is held intact. In the present example, the noise removal processing effect is weakened for the noted area. However, the area for which the noise removal processing is weakened is not limited to the noted area.

According to the fourth embodiment, noise removal processing dependent on a depth can be carried out. Through control of noise removal processing, a sense of stereoscopy can be adjusted and image quality can be improved.

### Fifth Embodiment

An image signal processing device and image signal processing method in accordance with a fifth embodiment will be described below.

The image signal processing device in accordance with the fifth embodiment is different from the image signal processing device of the first embodiment shown in FIG. 1 or the image signal processing device of the second embodiment shown in FIG. 6 only in an output of the parameter determination unit and processing of the image-quality correction processing unit. As for the other features, the image signal processing device in accordance with the fifth embodiment shares the same features with those in accordance with the first and second embodiments.

The parameter determination unit 104 produces image-quality correction processing parameters on the basis of inputted depth signals. As described in relation to the second embodiment, not only the depth signal but also a blur level may be employed. The image-quality correction processing unit 105 performs image-quality correction processing according to the parameters outputted from the parameter determination unit 104.

An example of the image-quality correction processing parameter will be cited on the assumption that the image-quality correction processing unit 105 performs contrast correction. For example, when contrast correction is performed, if a graph of a sigmoid function shown in FIG. 11 is used as a tone curve, a gain a in the sigmoid function is regarded as a parameter. FIG. 11 shows an example of the graph of the sigmoid function. The larger the a value is, the sharper the curve is. In addition, shading is enhanced.

According to a depth calculated by the depth estimation unit 103, the a value is varied for each pixel of partial are in an image. FIG. 9 includes graphs showing a relationship of association of a parameter intensity to a depth signal. The a value is determined according to the association plotted in, for example, FIG. 9. The association falls into a trapezoidal type in which the parameter intensity takes on a large value in relation to a certain range of depths and takes on small values in relation to the other depths, a step function type, a linear function type, or a curved type. Otherwise, a table to be referenced in order to determine the a value in association with the depth may be made available so that the a value can be set to an arbitrary value. As described in relation to the second embodiment, a focal area may be calculated based on a blur level, and a depth that causes the a value to become minimal may be determined for any area in an image which indicates the same parallax as the parallax of the focal area.

Accordingly, the parameter employed in contrast correction processing of the image-quality correction processing unit 105 can be varied for each pixel or partial area in an image. For example, such contrast correction processing can be performed that a sense of depth is enhanced by enhancing the shading in a noted area but not enhancing the shading in the other area. In the present embodiment, the shading in the noted area is enhanced. An area in which shading is enhanced is not limited to the noted area.

According to the fifth embodiment, contrast correction processing dependent on a depth can be carried out, and a sense of stereoscopy can be adjusted by controlling the contrast correction processing.

In the present embodiment, correction processing of a contrast has been presented. Alternatively, gray-scale correction processing may be performed, or light emission may be controlled for each area in a display device.

### Sixth Embodiment

FIG. 14 is a block diagram showing an image coding device in accordance with a sixth embodiment. An image coding device 130 is different from the image signal processing device of the first embodiment or the image signal processing device of the second embodiment shown in FIG. 6 only in processing of the parameter determination unit and processing of a coding processing unit. As for the other features, the image coding device shares the same features with the image signal processing devices of the first and second embodiment.

In FIG. 14, a device configured by modifying the parameter determination unit of the first embodiment shown in FIG. 1, and changing the image-quality correction processing unit thereof into a coding processing unit is cited as an example. A parameter determination unit 134 produces video coding parameters on the basis of inputted depth signals. As described in relation to the second embodiment, not only the depth signal but also a blur level may be employed. A coding processing unit 135 performs coding processing according to the parameters outputted from the parameter determination unit 134.

An example of the coding processing parameter will be described on the assumption that the coding processing unit 135 adjusts a quantization step. For example, when the quantization step is adjusted, the quantization step is varied for each macro block or partial area in an image according to a depth calculated by a depth estimation unit 133. For example, the quantization step is set to a small value for a nearby area, and is set to a large value for a deep area. Thus, a filter is selected based on a depth.

Accordingly, a parameter to be employed in quantization step adjustment processing of the coding processing unit 135 can be varied for each macro block in an image. While a natural sense of depth is held intact, coding reduction processing can be performed.

In the present embodiment, a quantization step is adopted as a coding parameter. Alternatively, a coding mode, a foreseeing method, a motion vector may be utilized and adjusted.

According to the sixth embodiment, coding processing dependent on a depth can be achieved. While a natural sense of stereoscopy is held intact, a coding volume can be reduced.

In the present embodiment, an example of performing coding processing alone is cited. Alternatively, the coding processing may be performed in combination with the image-quality correction.

### Seventh Embodiment

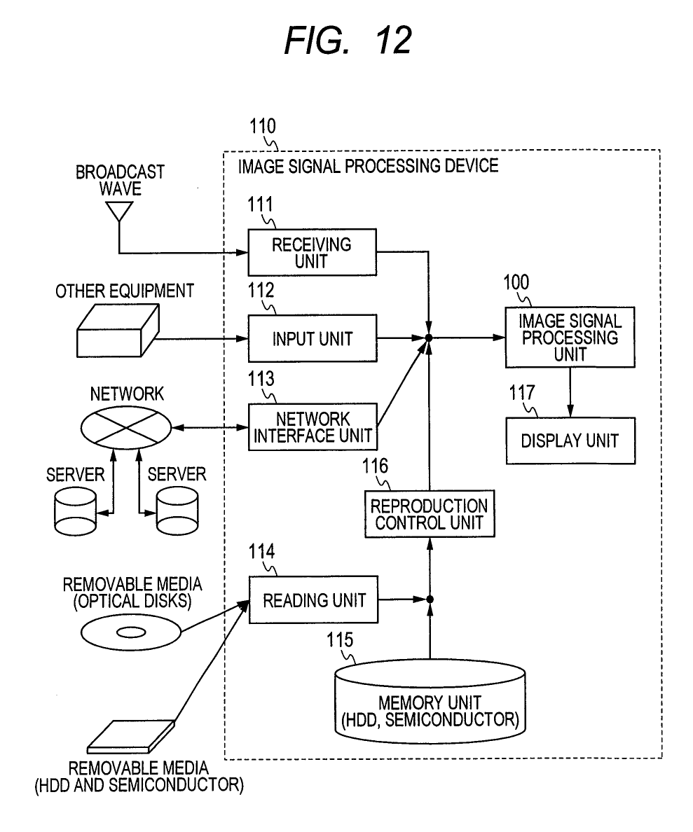

FIG. 12 shows an example of an image signal processing system in accordance with a seventh embodiment.

The image signal processing system includes an image signal processing device 110 and various devices connected to the image signal processing device 110. More particularly, the devices include an antenna through which a broadcast wave is received, a network on which servers are connected, and removable media (optical disk, hard disk drive (HDD), and semiconductor).

The image signal processing device 110 includes an image signal processing unit 100, a receiving unit 111, an input unit 112, a network interface unit 113, a reading unit 114, a recording unit 115 (HDD and semiconductor), a reproduction control unit 116, and a display unit 117.

As the image signal processing unit 100, the image signal processing unit included in any of the first to sixth embodiments is adopted. As an input image (raw image), an image convoluted to a broadcast wave received through the antenna is inputted from the receiving unit 111, or inputted from the network interface unit 113. Otherwise, an image stored in any of the removal media is inputted from the reading unit 114.

After the image signal processing unit 100 performs image-quality correction processing on the input image, the resultant image is outputted to the display unit 117 represented by a display.

### Eighth Embodiment

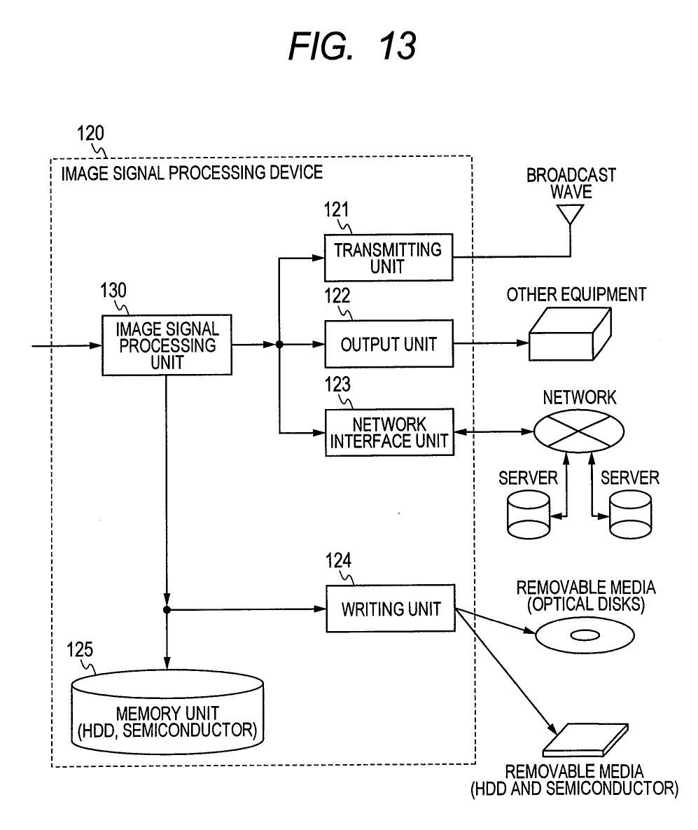

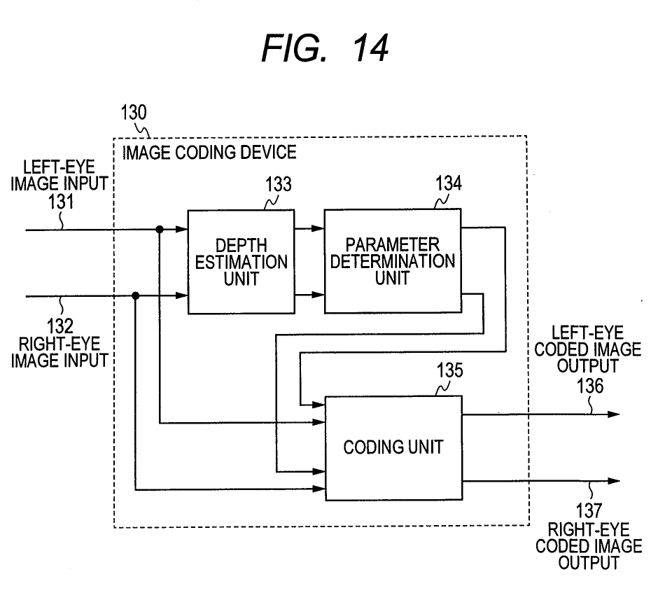

FIG. 13 shows an example of an image signal processing system in accordance with an eighth embodiment.

The image signal processing system includes an image signal processing device 120 and various devices connected to the image signal processing device 120. More particularly, the devices include an antenna through which a broadcast wave is transmitted, a network on which servers are connected, and removable media (optical disk, HDD, and semiconductor).

The image signal processing device 120 includes an image signal processing unit 130, a transmission unit 121, an output unit 112, a network interface unit 123, a writing unit 124, and a recording unit (HDD and semiconductor) 125.

As the image signal processing unit 130, the image signal processing unit employed in any of the first to sixth embodiments is adopted. After the image signal processing device 120 performs image-quality correction processing, the output image (corrected image) is outputted from the transmission unit 121 that transmits an image while convoluting the image to a broadcast wave to be radiated from an antenna, or outputted from the network interface unit 123. Otherwise, an image is written by the writing unit 124 so that the image can be stored in any of the removable media.

What is claimed is:

1. An image signal processing device comprising:
a parameter determination unit that when a first image for a left eye and a second image for a right eye are inputted, determines each of parameters concerning image-quality correction of an image on the basis of a magnitude of a positional deviation between associated pixels in the first image and second image respectively; and
an image-quality correction processing unit that adjusts a sense of depth of an image by utilizing the parameters.

2. The image signal processing device according to claim 1, further comprising a depth estimation unit that estimates a depth in an image on the basis of the magnitude of a positional deviation between associated pixels in the first image and second image respectively, wherein:
the parameter determination unit determines a parameter by utilizing the result of the estimation fed from the depth estimation unit.

3. The image signal processing device according to claim 2, further comprising a blur level estimation unit that estimates a degree of a blur in each of the first image and second image, wherein:
the parameter determination unit determines a parameter by utilizing the results of the estimations fed from the blur level estimation unit and depth estimation unit respectively.

4. The image signal processing device according to claim 1, wherein the image-quality correction processing unit performs high-resolution attainment processing by utilizing the parameters outputted from the parameter determination unit.

5. The image signal processing device according to claim 1, wherein the image-quality correction processing unit performs processing of enhancing or attenuating a high-frequency band by utilizing parameter information.

6. The image signal processing device according to claim 1, wherein the image-quality correction processing unit performs noise removal processing by utilizing the parameters.

7. The image signal processing device according to claim 1, wherein the image-quality correction processing unit performs contrast correction, gray-scale processing, or light emission control of a display device by utilizing the parameters outputted from the parameter determination unit.

8. An image signal processing method comprising:
when a first image for a left eye and a second image for a right eye are inputted, determining each of parameters concerning image-quality correction on the basis of a magnitude of a positional deviation between associated pixels in the first image and second image respectively; and
performing image-quality correction processing for adjusting a sense of depth of an image by utilizing the parameters.

9. The image signal processing method according to claim 8, wherein depth estimation that utilizes a parallax is performed based on the magnitude of a positional deviation between associated pixels in the first image and second image respectively, and each of parameters concerning image-quality correction is determined by utilizing the result of the depth estimation.

10. The image signal processing method according to claim 8, wherein a degree of a blur in each of the first image and second image is estimated, and image-quality correction is performed by utilizing the results of the estimations of the degree of a blur and the depth respectively.

11. The image signal processing method according to claim 8, wherein high-resolution attainment processing is performed by utilizing the parameters.

12. The image signal processing method according to claim 8, wherein processing of enhancing or attenuating a high-frequency band is performed by utilizing the parameters.

13. The image signal processing method according to claim 8, wherein noise removal processing is performed by utilizing the parameters.

14. The image signal processing method according to claim 8, wherein contrast correction, gray-scale processing, or light emission control of a display device is performed by utilizing the parameters.
